(19) United States
(12) Patent Application Publication
(10) Pub. No.: US 2014/0258138 A1
(43) Pub. Date: Sep. 11, 2014

(54) SYSTEM AND METHOD FOR OWNER ENDORSEMENT IN INTERFACE MANAGEMENT

(71) Applicant: COREWORX INC., Kitchener (CA)

(72) Inventors: Michael Edward Tennant, Kitchener (CA); Tony Yeung, Conestogo (CA); Kelly Ann Maloney, Kitchener (CA)

(21) Appl. No.: 13/790,976

(22) Filed: Mar. 8, 2013

(51) Int. Cl. G06Q 50/08; G06Q 10/10

(52) U.S. Cl. CPC G06Q 50/08; G06Q 10/103
USPC 705/301

(57) ABSTRACT

A system, method and computer program product provide for management of interfaces in a construction project. An interface point may have one or more interface agreements for performance by various contractors to complete the interface point under management of an owner/operator of the project. The workflow provides owner/operator interface managers control over the performance by the contractors. The workflow is configured to provide a user interface for brokering, by the owner/operator, respective interface agreement requests and responses by the contractors for completing a particular interface agreement. The user interface is configured to receive input from the interface managers to endorse the respective requests and responses and the workflow forwards the endorsed requests and responses accordingly thereby to control the performance. The workflow may be configurable to operate in accordance with more than one endorsement model.

### FIELD

The present matter relates generally to project management such as for capital projects and more particularly to a system and method for interface management between two or more parties of a project team.

### BACKGROUND

Construction projects are becoming more complex and larger in scale due in part to advances in technology and operations. These projects require many stakeholders, with different geographical locations and working cultures, collaborating with one another throughout a project life cycle. Effectively planning, designing, constructing, operating and maintaining these projects can require strong management and a sound technological foundation.

Interface management is identified as a key risk factor for major capital projects. A significant contributing factor is the number of interface dependencies that occur between multiple work packages, and the ability of a project team to manage and control these interfaces.

### SUMMARY

A system, method and computer program product provide for management of interfaces in a construction project. An interface point may have one or more interface agreements for performance by various contractors, under management of an owner/operator of the project, to complete the interface point. The workflow provides owner/operator interface managers control over the performance by the contractors. The workflow is configured to provide a user interface for brokering, by the owner/operator, respective interface agreement requests and responses by the contractors for completing a particular interface agreement. The user interface is configured to receive input from the interface managers to endorse the respective requests and responses and the workflow forwards the endorsed requests and responses accordingly thereby to control the performance. The workflow may be configurable to operate in accordance with more than one endorsement model.

There is provided a computer-implemented method for controlling the completion of an interface point in a construction project. The method comprises receiving data with which to define and store to the computer data store one or more interface agreements for the completion of the interface point, where respective interface agreements for performance by one or more contractors under the management of an owner/operator of the construction project; and, providing workflow for processing the completion of the one or more interface agreements by the one or more contractors under the management of an owner/operator, the workflow configured to provide a user interface for brokering, by the owner/operator, respective interface agreement requests and responses by the one or more contractors for completing a particular interface agreement.

The user interface may be configured to receive input from an owner/operator interface manager to endorse respective interface agreement requests and responses, the workflow forwarding the endorsed requests and responses accordingly thereby to control the performance of the respective interface agreements.

The workflow may be configured to notify the owner/operator interface manager of an interface agreement request or a response requiring endorsement.

The workflow may be configurable to operate in accordance with more than one endorsement model. For example, the workflow may be configurable to operate in accordance with a double endorsement model requiring endorsement by a first owner/operator interface manager responsible for a contractor submitting the request and by a second owner/operator interface manager responsible for a contractor responding to the request. The workflow may be configurable to operate in accordance with a single endorsement model requiring endorsement by one of a first owner/operator interface manager responsible for a contractor submitting the request or by a second owner/operator interface manager responsible for a contractor responding to the request.

The user interface may be configured to receive input from an owner/operator interface manager to forward respective interface agreement requests and responses for technical assistance before endorsing, the workflow forwarding the requests and responses accordingly thereby to control the performance of the respective interface agreements. The workflow may be configured to return technical assistance responses to the owner/operator interface manager to further process the endorsement.

The user interface may be configured to receive input from an owner/operator interface manager to return respective interface agreement requests and responses for clarification to a respective requesting contractor or responding contractor before endorsing, the workflow forwarding the requests and responses accordingly thereby to control the performance of the respective interface agreements.

The method may include providing one or more dashboards for monitoring the interface agreements.

System and computer program aspects ill also be apparent.

### BRIEF DESCRIPTION OF THE DRAWINGS

The present matter may be further understood by reference to following description in conjunction with the appended drawings in which:

FIG. 1 is a block diagram representing an interface point relationship model;

FIG. 2 is an illustration of an interface management solution architecture in accordance with an example;

FIGS. 3 and 4 are flow charts showing owner endorsement process flows in accordance with an example;

FIG. 5 is a representative notification, email;

FIGS. 6A and 6B are portions of screen shot showing a “My Work Items” user interface;

FIGS. 7A, 7B and 7C are portions of screen shot showing an “endorse response” user interface;

FIGS. 8, 9 and 10 represent various reporting views of the interface agreements; and

FIG. 11 is a screen shot of a packages user interface.

In the following description like numerals refer to like structures and process in the diagrams.

### DETAILED DESCRIPTION

In complex construction projects, the management of multiple contractors to effectively and efficiently complete various projects having common interfaces will often require collaborative approaches to communicate and broker agreements. For various reasons, such as, in order to control costs on cost reimbursable contractors, to maintain the integrity of potential proprietary information or to ensure that sufficient and detailed information is exchanged for interfaces, particularly when dealing with new technology, it is becoming increasingly important that the ability of the owner to intervene and correct course if necessary is provided.

Within this document, the following terms are understood to have the meanings provided:
EPCM Engineering, Procurement and Construction Management
Interface Agreement (IA) Interface agreements are used by contractors to request information and deliverables from other parties and provide the detail for all agreements made regarding an interface.
Interface Management A collective project management term used for capital projects to denote a management program for intersecting or dependent scopes of work or interface points.
Interface Manager (IM) The Interface Manager is responsible for the interface process, communication, and coordination and reporting. This individual is responsible for managing, identifying and resolving internal and external interfaces with respective client and contractor teams. Each EPC participating on the project should have an Interface Manager assigned who acts as a single point of contact for interface related issues and queries related to the EPCs work package(s)
Interface Point (IP) The point in which two or more contracting parties or independent systems meet or communicate with each other (e.g. a tie-in point).
Owner/Operator The organization funding and ultimately operating the asset related to the project being executed (i.e., Offshore Oil & Gas Platform)
PMC Project management consultant
Requesting Party The party requesting specific information or deliverables via an Interface Agreement and is tied to or related to a physical interface.
Responding Party The party responsible for providing the response to an Interface Agreement request
Technical Contact Individual working on the project who supports the Interface Manager role in providing technical content in response to Interface Agreement requests; very often this role is filled by discipline engineers
Work Package Defines work scope splits between contractors; subset of a project that represents the scope of work awarded through a contract to a single contractor

Interface points result from technical complexities, compressed design build time cycles, as well as issues such as environmental and regulatory requirements. The interface management solution described herein may be used to facilitate the interfaces between parties regarding roles and responsibilities; required date for providing interface information and identification of critical interfaces early in a project. The interface points may be between divisions of a single company or may exist between companies that have no connection other than through the performance of the work for respective work packages coordinated by the solution.

The interface management solution may take the form of a system, method or computer program product (e.g. software instructions stored to a medium in a non-transitory manner for instructing a processor). The interface management solution may assist to provide early identification of issues with potential for impact to cost or schedule and to provide standardization across projects. Visibility into the process allows each party to react to potential issues in a timely manner.

The interface management solution uses an interface point to document and track interfaces within a particular project. Interface points are commonly used to identify physical interfaces (i.e. Piping—Fire Water, Piping—LP Fuel Gas to Burn Pit, Civil—Road interface), but can also be used to track commercial or environmental interfaces. It is common practice to identify these interfaces during Front End Engineering and Design (FEED) and include them as part of the work package definition for a contract award.

Interface agreements are used by contractors to request information and deliverables from other parties. Interface agreements require the review and approval of a respective contractor's Interface Manager. Interface managers are the single point of contact for each contractor. The interface manager should have sufficient authority to represent and make binding decisions on behalf of their organization. Interface agreements may be tracked via work processes of the interface management solution, and include alerts and notifications, for example, so that timely responses are received.

Work processes are provided within the interface management solution for each of the following:

Issue Work Package

Interface Points

Interface Agreements

Action Items

Change Request

IM Notification

The IP, IA, action item and change request work processes (workflow) include one or more online forms which are completed, submitted and routed via workflow for review and approval. Costs may be controlled through the use of interface monitoring and control tools that allow managers to quickly identify and respond to changing project risks. The interface management solution may be configured with workflow-driven, collaborative tools for early identification, prioritization, and quick resolution of interface issues. Members of the Owner/Operators team and external contractors have the means to communicate with one another as well as monitor, control and close-out all interfaces related to the project. The interface management solution may be configured to provide real-time visibility to interface issues in support of a deadline-driven project environment. Interface managers, both internally and externally can be provided with the tools needed to resolve interfaces issues early; avoid disconnects between major work scopes and between operator and contractor.

Roles and responsibilities for different users within the interface management solution may be defined to reduce or eliminate ambiguity related to interface points and interface agreements with total visibility between the interfacing parties. Teamwork is encouraged, duplication of effort is reduced, agreements are quickly signed and greater clarity is provided.

### Structure of Interface Information

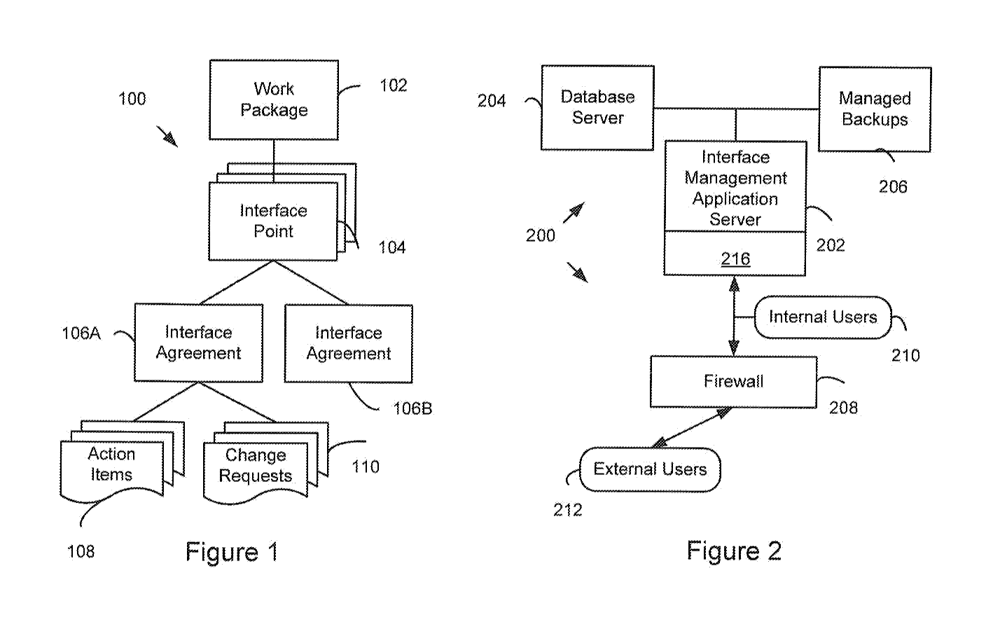

The interface management solution supports a structured approach to handling and managing the interface points for large capital projects starting from the FEED stage and progressing to the Engineering Procurement and Construction (EPC) stage. FIG. 1 illustrates this process which starts with identifying the work packages 102 and progresses to the identification and creation of one or more interface points (e.g. 104). Interface points can be created at any point during the project's life cycle and optionally included in contract bid packages.

After contract award, contractors have the responsibility to manage interface points (104) using interface agreements in the interface management solution to document the deliverables and information required by other contractors. An interface point 104 may give rise to one or more interface agreements (e.g. 106A and 106B) during the life cycle of the completion of the work package, for example, at various phases within the completion. Mutual agreement and acceptance are required by contract parties before the interface agreement (e.g. 106A) can be closed. A particular interface point 104 is not closed until all related interface agreements (106A and 1066) have been closed and agreed. Contractors are responsible for the successful close out of interface points (104) which fall under their respective work package (102).

The major components of the interface management solution architecture 200, outlined in FIG. 2, comprise: an application server 202, a database server 204, managed backup repository 206, a firewall 208, internal user computers 210, and external user computers 212. It is understood that the architecture 200 is simplified, for example, omitting various network infrastructure.

The application server 202 provides components of the interface management application 216 for the user computers (210 and 212) and interfaces with the database server 204 and the managed backup server 206. The database server 204 is where all databases used by the application are managed. In some configurations, the database may be Oracle® 10 g or SQL Server 2008™ from Microsoft Corporation.

Internal user computers 210 represent users that access the solution from inside the firewall 208. External user computers 212 represent external users that are remote and access the application server 202 through the firewall 208 using a secure connection.

It is understood that the servers 202, 204, 206 comprise computer devices coupled for communication via one or more networks and that the server computer devices may comprise programmable processors and one or more data stores (e.g. memory or other storage devices/media) having instructions for configuring the execution of the processors to provide the features and functions. For scalability and robustness, commercial computing devices configured as dedicated servers may be used. The various user computers may also comprise similar computing devices though typically they will comprise computing devices (client machines) configured for individual users, such as laptops, tablets, desktops, workstations and smart phones.

The various computing devices may comprise operating systems, communication sub-systems (e.g. wired and/or wireless based), user input and/or output devices such as keyboard, displays including touch screen displays, pointing devices, audio input, audio output, etc. The interface management application 216 may be configured as a browser-based application. It is understood that other application configurations such as native applications for specific operating environments may be employed. User computers may be configured with browsers and other applications for example.

The interface management application 216 provides a user interface to define work packages for a particular project. In addition, the user interface provides the capability to specify the contractor awarded the work package upon completion of contract awards. Each work package will include one or more interface points and the user interface provides a capability of defining interface points in relation to specific work packages. Over the life of the project, interface agreements are raised by contractors. The user interface provides the capability to define interface agreements and link each to the appropriate interface point. In the context of the interface agreement work process, requests will be made of one contractor by another. The work process will automatically route these requests to the correct users. As described further, the interface management application 216 provides Owner/Operators with the capability to endorse interface agreement requests and responses between contractors.

### Owner Endorsement

In the majority of cases, capital projects will encourage open and direct lines of communication between parties involved in the engineering, procurement and constructions stages of a project. Interface agreements can involve requests which may take significant time and cost. There may be instances when the Owner/Operator wants to be involved in the direct dealings between contractors. For example, when dealing with cost reimbursable contracts it is often desirable to have the option to review and approve (endorse) a request from another party before the request is submitted to the responding party. In another example, one contractor may request the disclosure of proprietary information from another and the Owner/Operator may wish to broker that request to ensure its accuracy and give guidance to the requesting and responding contractors. There may be other instances where an owner wishes to be involved. This capability may be referred to as “Owner Endorsement”. Owner Endorsement lets the owner review each request, discuss with the parties involved if needed and work with the contractor to prioritize.

Mega capital projects in the Oil & Gas industry are funded by Owner/Operator organizations such as Chevron Corporation, Exxon Mobil and BP Global, Owner Endorsement is geared towards the company responsible for the project management of these mega capital projects, In some projects, project management will be handled directly by the Owner/Operator, or can be contracted out to an EPCM organization or to a PMC organization. Therefore, the endorsement may be handled by users in one of these organizations who will be referred to as the project management team.

In complex mega projects, the project management team for an Owner/Operator may include two or more Owner/Operator IMs. The interface management application 216 provides a capability to assign an Owner/Operator IM to particular contractors responsible for respective work packages. In the context of an interface agreement between two contractors, two different IMs representing the Owner/Operator may be associated with and have responsibilities for managing the IA. One IM, the other IM or both of the IMs may desire endorsement capabilities for managing the IA.

To provide Owner Endorsement the interface agreement work process in the application 216 is configured to include endorsement steps to be completed by the IMs of the project management team. In one example, the interface management application 216 supports a configurable option of including a double owner endorsement (where both IMs endorse the agreement), a single owner endorsement (where one or the other IM endorses) or no owner endorsement depending on eligibility.

In some situations, it may be desired to have endorsement when a new request in relation to an IA is submitted via the interface management application 216; and a single owner endorsement task is handled by the Interface Manager responsible for the work package of the responding party. In other situations, endorsement is only required by the Interface Manager responsible for the work package of the requesting party. In some situations, endorsement is required by both parties at all times. And in other situations, endorsement will be turned off altogether. The work process in the example embodiment of application 216 is defined to be flexible to handle simple configuration to determine which level of endorsement is required.

Owner endorsement can be made flexible and configurable in that it offers the ability to endorse requests based on pre-defined criteria. In some situations, for example cost reimbursable contracts, endorsement may be required for all requests to and from a contractor working under a cost reimbursable contract. In other situations, criteria attributed to the physical interface such as interface type, priority of the interface (e.g. does the interface involve any activities on the critical path) and the potential cost and/or schedule impact the interface represents. Owner endorsement may be required only on the initial request and not on the response; or on the response and not on the initial requests. Both scenarios should also take into consideration other criteria, if configured (e.g. endorsement only for those contractors/packages working under cost reimbursable contracts).

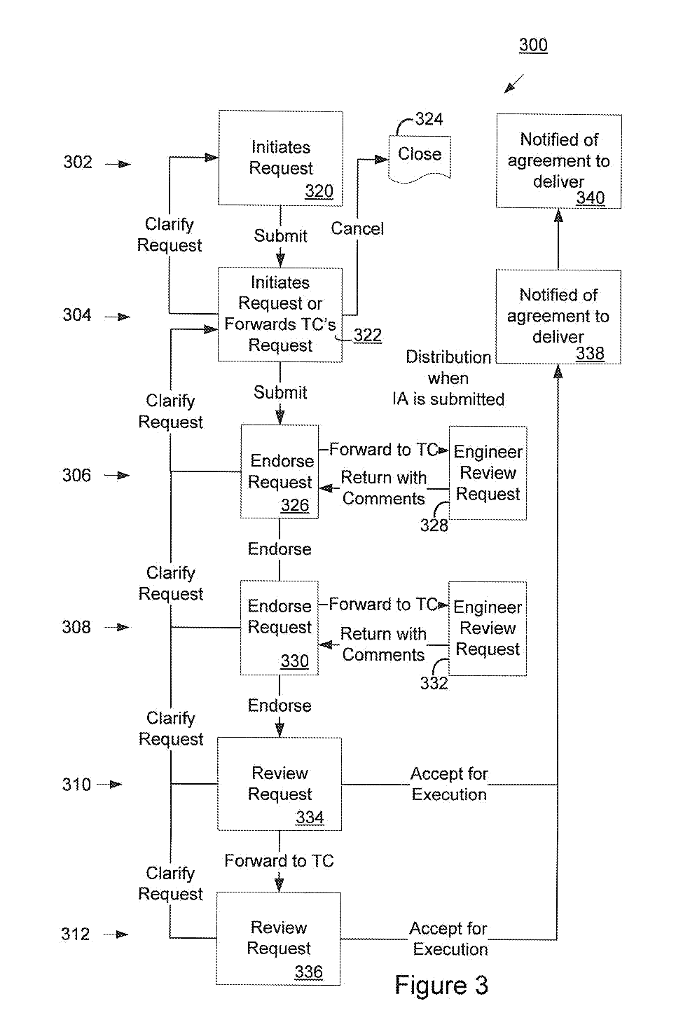

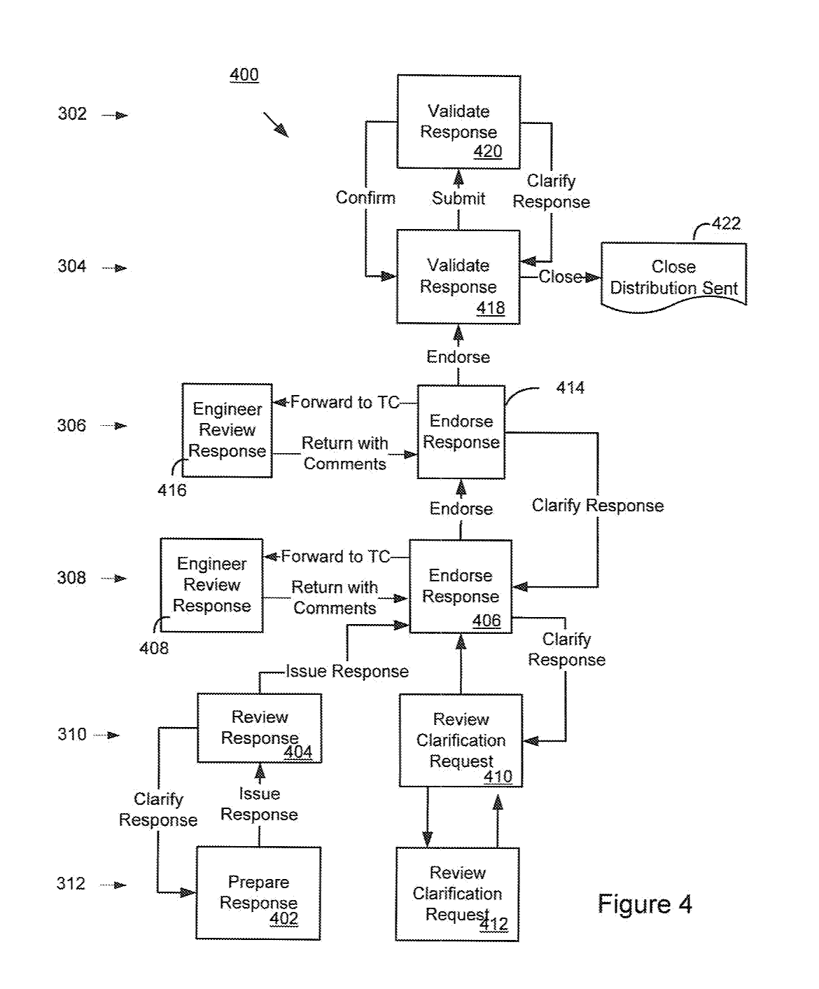

FIGS. 3 and 4 illustrate a simplified representation of the Owner Endorsement work processes of the Interface Management application 216 in accordance with one example. FIGS. 3 and 4 are described further herein below following a general description of selected components and work processes of the interface management application 216.

As described, owner endorsement is handled by IMs of the project management team with an IM assigned to monitor the progress of each work package. In the present example scenario, there is an interface agreement in respect of an interface point for completion by a pair of respective contractors, contractor A and contractor B each having a contractor Interface Manager (e.g. Contractor A—IM and Contractor B—IM) and a Technical Contact (TC) (e.g. Contractor A—TO and Contractor B—TC). Intermediation of the IA in the present scenario represented in FIGS. 3 and 4 requires that an IA request and an IA response are both endorsed by the respective Owner/Operator IMs. This endorsement occurs before the IA response is received by the responder (contractor B) and before the IA response is received by the requestor (contractor A). The Owner/Operator IMs may have access to respective owner TCs and may choose to forward the particular IA request/response for technical review before endorsing. It will be apparent to a person of skill in the art that FIGS. 3 and 4 and the applicable work processes can be modified for single owner endorsement by a respective Owner IM.

The endorsement steps are designed to facilitate project governance of all Interface agreements involving external contracting parties.

### Interface Agreement Workflow: The Endorsement Model

In the interface management application 216, the Owner/Operator IMs are provided with the ability to endorse interface agreements which are submitted. Before a new request is issued, the IM responsible for the work package associated to the interface agreement is provided with the ability to review the content of the request for accuracy and completeness. If required, the request is sent back to the requesting party contractor for clarification. If accepted by the IM, the IM will endorse the IA and the workflow will proceed (i.e. the request is sent to the responding party contractor).

Endorsement tasks may be assigned using a responsibility matrix configured for the project. Users must be defined as authorized users with access to the project. The defined users may have specific authorities and responsibilities (e.g. within a defined work group) and will be associated with specific individuals of the owner teams. As noted, a user receiving an endorsement task in the work flow may have access to a technical contact for assistance. The technical contact choice may be restricted to a set of defined contacts within a particular team and/or project. An endorsement task may be reassigned to another appropriate user. An endorsement task may be generally assigned to a work group such that any one of the users in the group may complete the task.

In the present example of the interface management application 216, users with endorsement task responsibilities relative to a “request” have the following workflow actions available:
Endorse—workflow proceeds to next step
Clarify Request—request is sent back to the Requesting IM
Forward to TC—request is sent to a TC of the Endorser's choice; list of available TCs should only include those from the Site Owner contracting party
Save as Draft

In the present example of the interface management application 216, users with endorsement task responsibilities relative to a “response” have the following workflow actions available:
Endorse—workflow proceeds to next step
Clarify Response—request is sent back to the Responding IM
Forward to TC—request is sent to a IC of the Endorser's choice; list of available TCs should only include those from the Site Owner contracting party.
Save as Draft

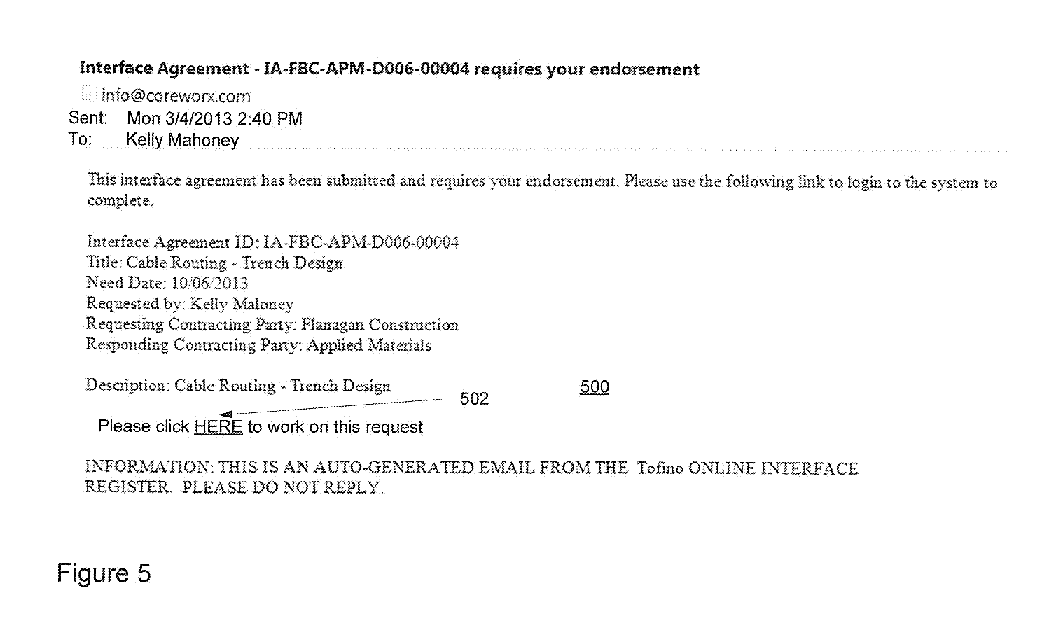

An email notification may be communicated to an assigned user when an endorsement task is assigned to them. The email may contain basic information about the request and may comprise with a link to the interface management application 216, for easy access. FIG. 5 illustrates a representative email 500 when an endorsement task is initiated (e.g. by requestor or responder). Email 500 represents a new interface agreement request. Similar content may be provided for a response. A link 502 may be provided to invoke the application from an email application.

To support reporting and searching, it is beneficial for users to be able to filter Interface agreements by status. The status indicates to the user where the Interface agreement is in its life cycle. The user can then determine, based on the status of an interface agreement(s) where, if any, a bottleneck exists and deal with it.

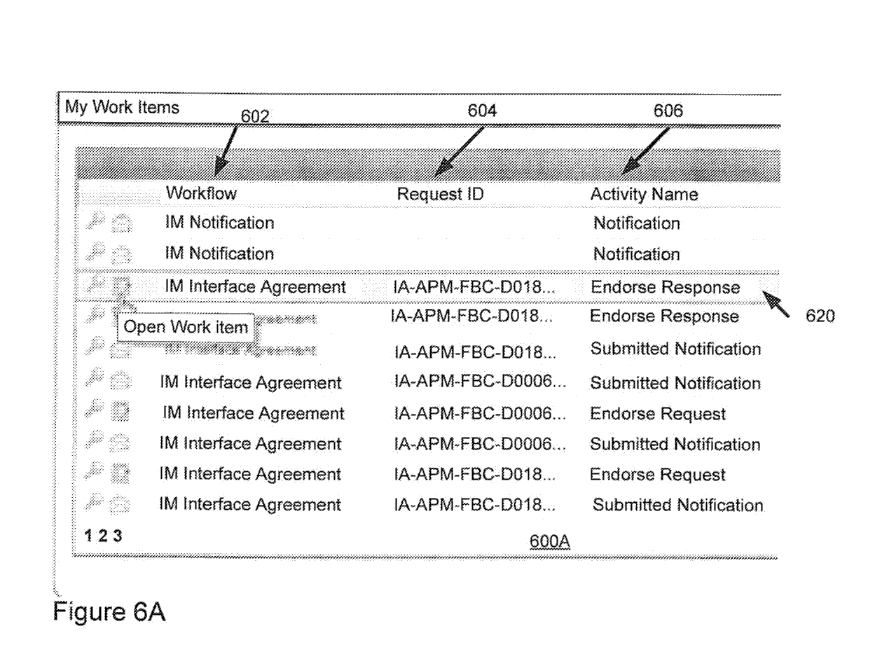

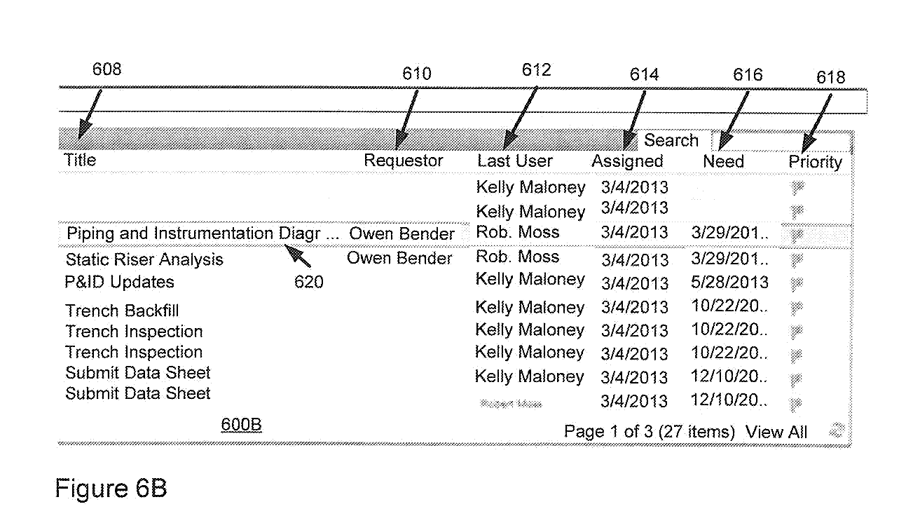

FIGS. 6A and 6B illustrate left side portion 600A and right side portion 600B of a “My Work Items” user interface (collectively 600) such as for an Owner/operator IM. The user interface provides a manner to see work items to be performed and may be filter red (e.g. via a search) and sorted variously (e.g. by selecting a column heading). Portion 600A shows for each item the following columns: a workflow name 602, particular request ID 604 (e.g. for an interface agreement) and activity name 706 (e.g. endorse response). Respective work items (e.g. 620) may be opened (invoked) from the table. Portion 600B shows for each item the following columns: title 608, requestor 610, last user 612, assigned date 614, need date 616 and a priority flag 618.

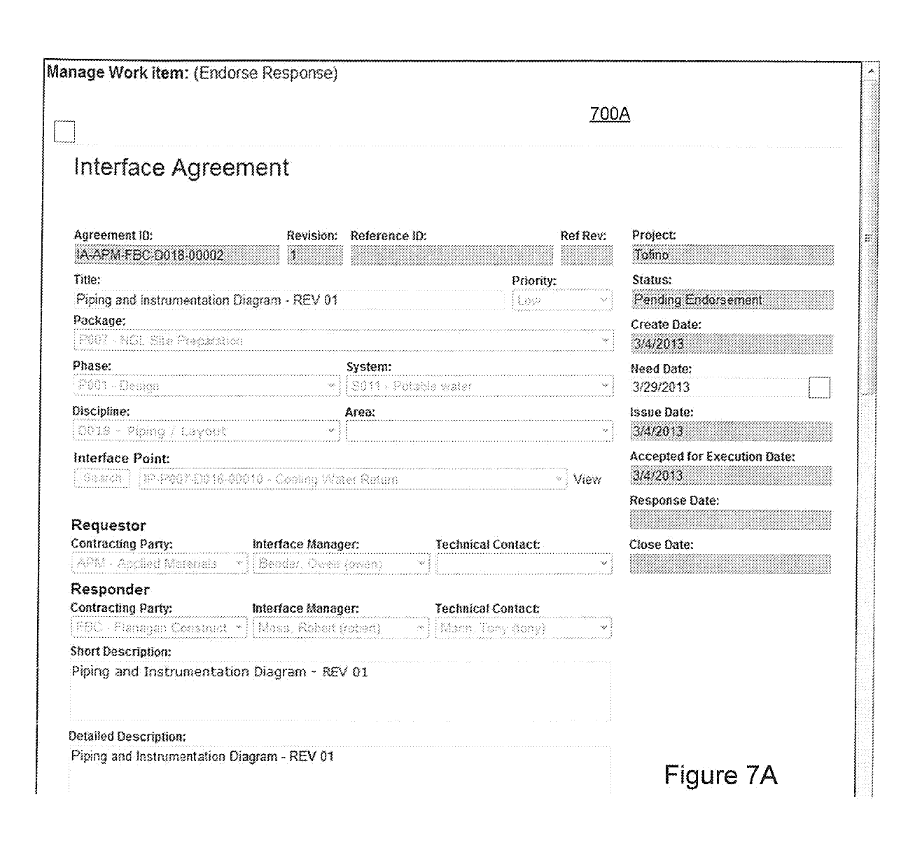

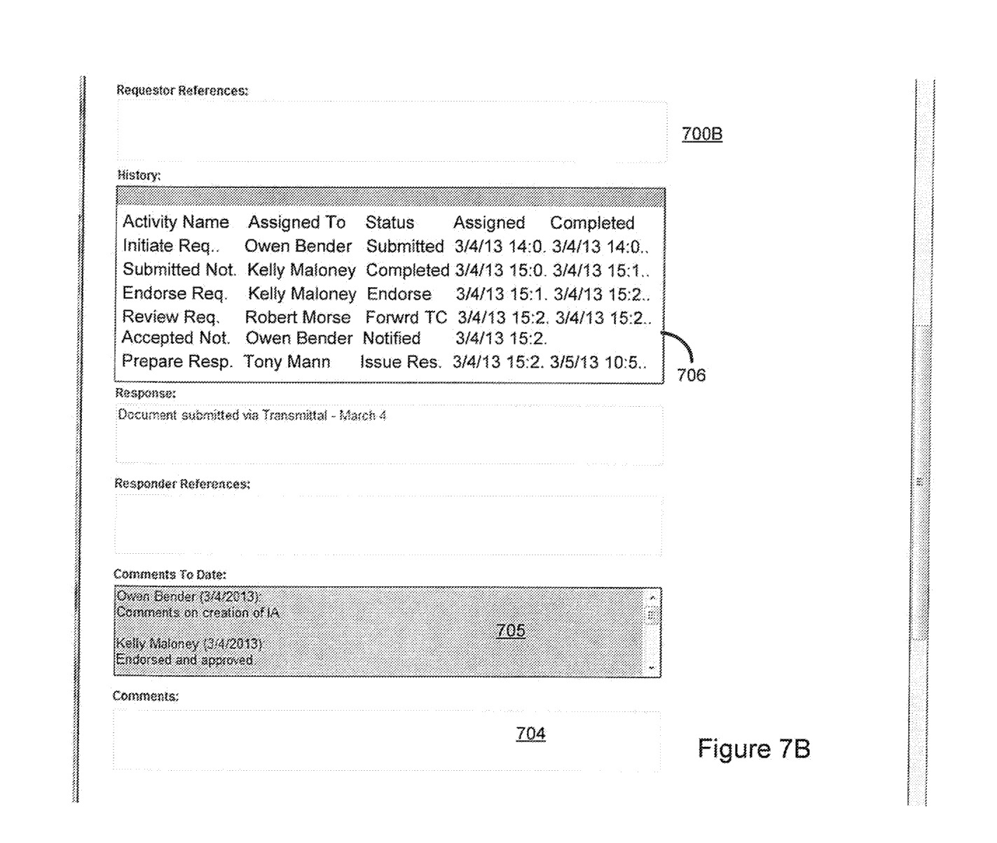

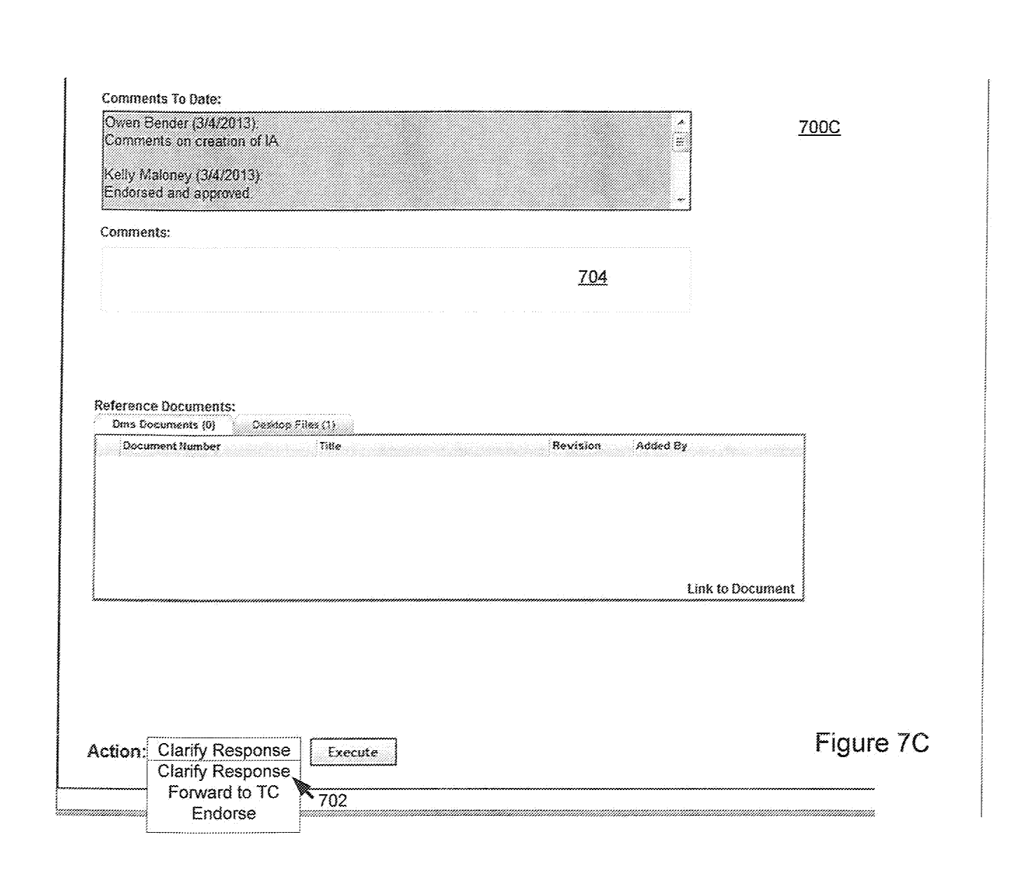

FIGS. 7A, 7B and 7C show top 700A, middle 700B and bottom 700C portions (collectively 700) of an “endorse response” work item user interface for a particular interface agreement such as may be invoked from a “My Work Items” user interface 600. User interface 700 shows interface agreement information (such as to which package and IP it relates), selected project information as well as provides controls (user input functionality) to complete the actions for an endorsement step. A similar view of the IA may be provided for request and response endorsement. A similar view may be provided to contractor IMs for their tasks. Controls for manipulating certain project and/or IA data may be disabled such that the various data fields in various views for respective users limit the activities that may be undertaken. For example, a contractor IM may not be permitted to modify project data etc.

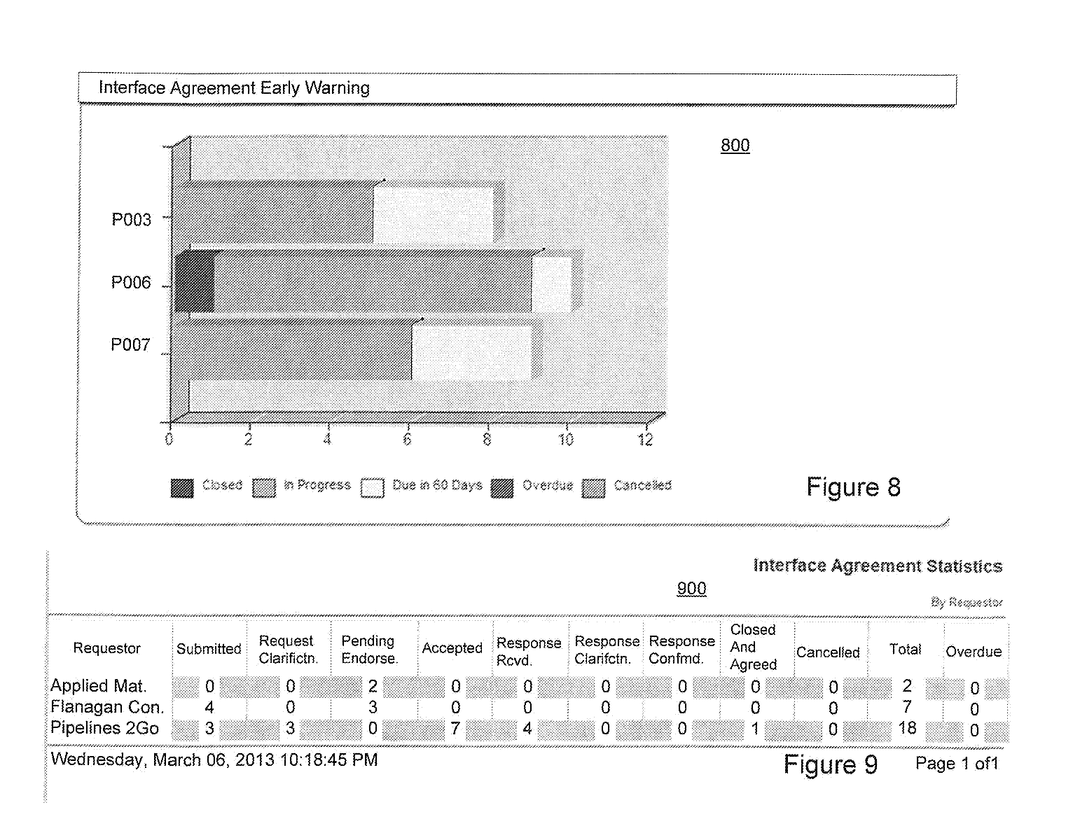

FIG. 7C shows a control 702 with which to request clarification, forward to a TC or endorse. One or more comment controls (e.g. 704, 705) may also be provided to annotate the IA request or review prior comments as the IA passes through the work flow. FIG. 8B shows history information 706 setting out the various activities (e.g. initiate request, various notifications, endorse request, review request, prepare response, endorse response etc.) and the status as undertaken in relation to the IA by the various IMs.

In response to a requesting contractor IM submitting a request for endorsement, the status of the interface agreement may be assigned ‘Pending Endorsement’ and will remain in this status until both endorsement steps (requestor endorsement and responder endorsement) have been completed. Once endorsed, the interface agreement is then submitted to the responding party and the status will be ‘Submitted’. If the responding party accepts, the status is “Accepted”. If clarification is required, “Request Clarification” is the status, On return from the responding party, the initial status is once again “Pending Endorsement” and once endorsed is “Response Received”. Clarification may occasion a ‘Response Clarification’ status. Following acceptance by the requesting contractor IM, the status is ‘Closed and Agreed’. Interface agreements may be cancelled e.g. at early stages.

The interface management application 216 may provide dashboards for presenting interface agreements, change requests and other information to users, such as Owner/Operator Ns and contractor Ns, typically via a display screen of the user's computer. The dashboards may be configured to include a ‘Pending Endorsement’ status so that a contractor IM can visually see any potential bottlenecks in the process and quickly deal with these issues as they arise. The interface management dashboards may be configured to automatically recognize new status values. The dashboard may take all statuses and group same according to the Need Date—Pending Endorsement included.

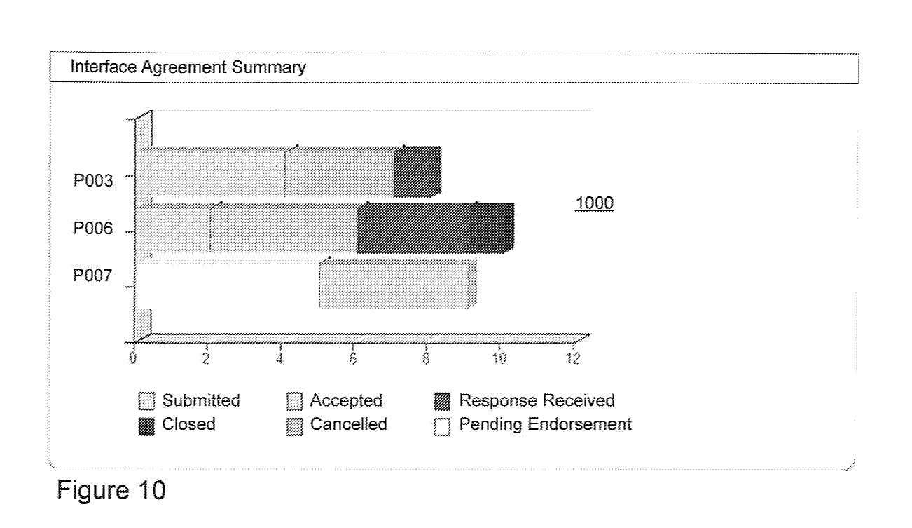

The interface management application 216 may provide reports for presenting information, which reports may be displayed on a display screen or printed, shared, etc. The reports may also be configured to include the ‘Pending Endorsement’ status so that an IM can visually see any potential bottlenecks in the process and quickly deal with these issues as the arise. An Interface Agreement Statistics Report may present ‘Pending endorsement’ status (by Requestor) and (by Responder). FIGS. 8, 9 and 10 represent various reporting views, such as dashboards, of the interface agreements. FIG. 8 is a graphical representation 800 of the progress in the work flow life cycles of interface agreements for particular packages. FIG. 9 is a table 900 showing interface agreements status counts by requestor contractor, for example, to assist an Owner/Operator. FIG. 10 is a graphical representation 1000 showing an IA summary by project and by status.

### Project Property to Determine if Endorsement is Used

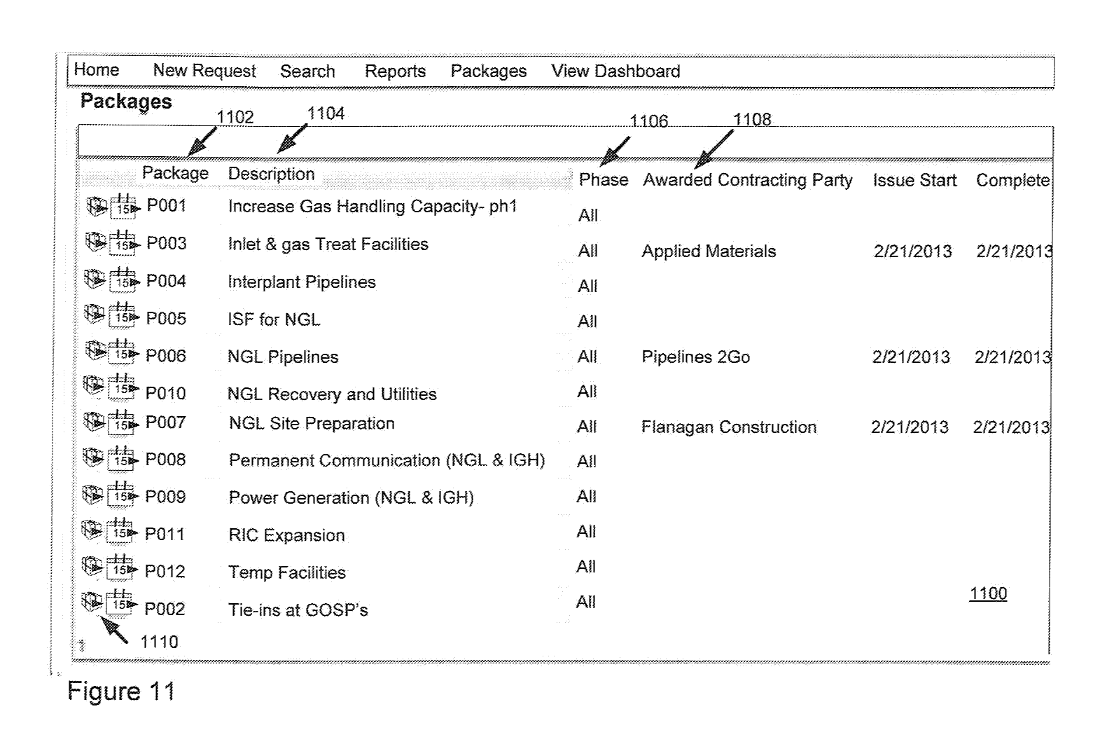

Within the interface management application 216, in the present example, the endorsement model may be applied at the project level to apply to all IAs within the project or at the package level, to apply to all IAs for a particular package. A property ‘endorsement enabled’ may be employed and set to either Yes or No at the project level (not shown). A single workflow template may be deployed in application 216, which uses the configured property value to determine which path each interface agreement workflow instance will take. There may also be a capability to opt out (or in) at the package level, for example, when the property is set (or not set) at the project level. The Interface Manager may have different contracting strategies to support. When dealing with reimbursable contracts, there is a higher need for owner endorsement of interface agreements. In lump sum contracts the owner Interface manager responsible for the contract may choose to opt out of endorsement, accepting IM notifications as a means of oversight. FIG. 11 is a screen shot of a packages user interface 1110. User interface shows information in columnar form such as package ID 1102, description 1104, phase 1106, awarded contractor 1108, issues. Package properties may be viewed and set (not shown) such as by invoking control 1110 to present an applicable user interface. Properties may be presented in a hierarchical list or other form as is known.

### Change Request Workflow—Addition of the Endorsement Model

The interface management application 216 provides the ability to ensure that all Change Requests associated to interface agreements are endorsed. Change requests can result in significant change to deliverables, and, as with interface agreements, if the contract is a cost reimbursable contract or if the technology related to the interface agreement or change request is new or proprietary in nature, endorsement may be desired. As with the interface agreement work process, the change request work process will include endorsement tasks based on the configured properties for the project (‘Endorsement Enabled’ and ‘Exclude from Endorsement’) and predefined criteria on interface points. Users responsible for the endorsement tasks are similarly identified as per the IA work process. The endorsement tasks may be assigned to a group of qualified users and may be reassigned. The endorsement task offers the user two choices; ‘Endorse’, signifies their acceptance of the change request, or ‘Clarify Request’, which returns the request to the originator for clarification and/or changes. The user tasked with the endorsement may be restricted from updating/changing the information (data fields) of the change request itself. Email notification may be supported.

FIG. 3 illustrates simplified owner endorsement work processes 300 in respect of a IA when a request is issued for the following users: contractor A—TC 302, contractor A—IM 304, first owner IM 306 (associated with contractor A), second owner IM 308 (associated with contractor B), contractor B—IM 310, contractor B—TC 312. FIG. 4 illustrates simplified owner endorsement work processes 400 in respect of an interface agreement when a response is received for the same user set.

With reference to FIG. 3, contractor A—TC 302 may issue a request (320) and submit same to contractor A—IM 304. At 322, Contractor A IM 304 may take various actions such as request clarification of the request (to step 320) to send it back to contractor A—TC 302, cancelling the request (to 324) or forward/submit it to first owner IM 306 for endorsement (to 326). It is also understood that contractor A—IM 304 may originate a request (e.g. without TC assistance) and submit it to first owner IM 306. At 326, first owner IM 306 may take various actions such as return the request for clarification (back to 322), endorse the request and forward the request to second owner IM 308 (to 328). At 326, first owner IM 306 may forward the request to an owner TC for consideration prior to endorsement or requesting clarification (to 328). At step 328, the owner TC reviews and returns the request to first owner IM 306 (back to 326).

At 330, second owner IM 308 receives the request and may take similar actions as taken by the first owner IM 306. That is, actions may include, request assistance from a TC (to step 332), request clarification (back to step 322) and endorse and forward (to step 334). At 334, contractor B—IM 310 receives and reviews the request. Actions of contractor B IM 310 may include return for clarification (back to step 322), request contractor B—TC 312 assistance to review (to step 336) and accept for execution (to step 338). If contractor B—TC 312 receives the request at step 336, actions may include: return to contractor A—IM 304 for clarification (back to step 322) and accept for execution (to step 338). Contractor B—IM 310 also may have the ability to issue the response (not shown).

At 336, contractor A—IM 304 is notified of contractor Bs acceptance to deliver. At 338, contractor A—TC 302 is notified of contractor B's acceptance to deliver.

With reference to FIG. 4, there are shown operations for a response from contractor B to a request from contractor A. Contractor B—TC 312 may prepare a response (step 402) and issues same to same to contractor B—IM 310. At 404, contractor B—IM 310 may take various actions in respect of the response such as request clarification (to step 402), sending it back to contractor B—TC 312, or forward it to second owner IM 308 for endorsement (step 406). At 406, second owner IM 308 may take various actions such as: forward the response to an owner TC (to step 408) for assistance; return the response for clarification (to step 410); and endorse the response and forward the response to first owner IM 306 (to step 414). At step 408, the owner TC reviews and returns the request to second owner IM 308 such as with comments. At 410, contractor B—IM 310 may take various actions in respect of the request to clarify the response. Contractor B —310 may forward the clarification request to contractor B—TC 312 (to step 412) and receive a clarified response or may return the clarified response to step 406 for endorsement. That is contractor 13—IM 310 may or may not require assistance from contractor B—TC 312 to clarify the response.

At 414, first owner IM 306 receives the request and may take similar actions as second owner IM 308 has available at step 406. That is actions may include, request assistance from a TC (to step 416), request clarification (to step 406) and endorse and forward (to step 418). At 418, contractor A—IM 304 receives and reviews the response for validation. Actions of contractor A—IM 304 at 418 may include return for clarification (to step 414), submit response to contractor A—TC 302 for validation assistance (to step 420) and close the agreement (to step 422). If contractor A—TC 312 receives the response at step 420, actions may include: return response to contractor A—IM 304 for clarification (to step 418) and confirm response for validation (to step 418) thereafter to be closed.

It will be appreciated that application 216 presents the applicable tasks for the respective IMs and TCs in the IA work processes and receives input from such users, for example, to receive certain data and invoke certain actions. Application 216 saves (e.g. stores to database 204) a record of activities (such as the data input, user, time and date, etc.) to assist with the prosecution of the IA via the work flow steps and for monitoring activates such as for reporting to the project management team and the contractor project management teams (e.g. contractor IMs). The application 216 can maintain a history of what happened, who did what and when it was done. The application 216 can communicate the progress among the various users in response to the actions taken, for example, notifying a respective Owner/Operator IM that ‘Endorse Response’ and/or ‘Endorse Request’ work items in relation to specific IAs are awaiting action by the Owner/Operator IM. Application 216 thus assists to control how the project is completed. Application 216 assists to control completion of the project, for example, by requiring endorsement of particular interface agreements before the interface agreement can be closed and thus before the associated interface point and associated work package are closed.

It will be appreciated by those of ordinary skill in the art that the matter can be embodied in other specific forms without departing from the spirit of essential character thereon.

What is claimed is:

1. A computer-implemented method for controlling the completion of an interface point in a construction project, the method comprising:
receiving data with which to define and store to the computer data store one or more interface agreements for the completion of the interface point, where respective interface agreements for performance by one or more contractors under the management of an owner/operator of the construction project; and,
providing workflow for processing the completion of the one or more interface agreements by the one or more contractors under the management of an owner/operator, the workflow configured to provide a user interface for brokering, by the owner/operator, respective interface agreement requests and responses by the one or more contractors for completing a particular interface agreement.

2. The method of claim 1 wherein the user interface is configured to receive input from an owner/operator interface manager to endorse respective interface agreement requests and responses, the workflow forwarding the endorsed requests and responses accordingly thereby to control the performance of the respective interface agreements.

3. The method of claim 2 wherein the workflow is configured to notify the owner/operator interface manager of an interface agreement request or a response requiring endorsement.

4. The method of claim 2 wherein the workflow is configurable to operate in accordance with more than one endorsement model.

5. The method of claim 4 wherein the workflow is configurable to operate in accordance with a double endorsement model requiring endorsement by a first owner/operator interface manager responsible for a contractor submitting the request and by a second owner/operator interface manager responsible for a contractor responding to the request.

6. The method of claim 4 wherein the workflow is configurable to operate in accordance with a single endorsement model requiring endorsement by one of a first owner/operator interface manager responsible for a contractor submitting the request or by a second owner/operator interface manager responsible for a contractor responding to the request.

7. The method of claim 1 wherein the user interface is configured to receive input from an owner/operator interface manager to forward respective interface agreement requests and responses for technical assistance before endorsing, the workflow forwarding the requests and responses accordingly thereby to control the performance of the respective interface agreements.

8. The method of claim 7, wherein the workflow is configured to return technical assistance responses to the owner/operator interface manager to further process the endorsement.

9. The method of claim 1 wherein the user interface is configured to receive input from an owner/operator interface manager to return respective interface agreement requests and responses for clarification to a respective requesting contractor or responding contractor before endorsing, the workflow forwarding the requests and responses accordingly thereby to control the performance of the respective interface agreements.

10. The method of claim 1 comprising providing one or more dashboards for monitoring the interface agreements.

11. A system comprising at least one processor and storage device storing instructions and data for configuring the execution of the at least one processor to control the completion of an interface point in a construction project, the system configured to:
receive data with which to define and store to a computer data store one or more interface agreements for the completion of the interface point, where respective interface agreements are for performance by one or more contractors under the management of an owner/operator of the construction project; and,
provide workflow for processing the completion of the one or more interface agreements by the one or more contractors under the management of an owner/operator, the workflow configured to provide a user interface for brokering, by the owner/operator, respective interface agreement requests and responses by the one or more contractors for completing a particular interface agreement.

12. The system of claim 11 wherein the user interface is configured to receive input from an owner/operator interface manager to endorse respective interface agreement requests and responses, the workflow forwarding the endorsed requests and responses accordingly thereby to control the performance of the respective interface agreements.

13. The system of claim 12 wherein the workflow is configured to notify the owner/operator interface manager of an interface agreement request or a response requiring endorsement.

14. The system of claim 12 wherein the workflow is configurable to operate in accordance with more than one endorsement model.

15. The system of claim 14 wherein the workflow is configurable to operate in accordance with a double endorsement model requiring endorsement by a first owner/operator interface manager responsible for a contractor submitting the request and by a second owner/operator interface manager responsible for a contractor responding to the request.

16. The system of claim 14 wherein the workflow is configurable to operate in accordance with a single endorsement model requiring endorsement by one of a first owner/operator interface manager responsible for a contractor submitting the request or by a second owner/operator interface manager responsible for a contractor responding to the request.

17. The system of claim 11 wherein the user interface is configured to receive input from an owner/operator interface manager to forward respective interface agreement requests and responses for technical assistance before endorsing, the workflow forwarding the requests and responses accordingly thereby to control the performance of the respective interface agreements.

18. The system of claim 17, wherein the workflow is configured to return technical assistance responses to the owner/operator interface manager to further process the endorsement.

19. The system of claim 11 wherein the user interface is configured to receive input from an owner/operator interface manager to return respective interface agreement requests and responses for clarification to a respective requesting contractor or responding contractor before endorsing, the workflow forwarding the requests and responses accordingly thereby to control the performance of the respective interface agreements.

20. A computer program product comprising a computer readable non-transitory tangible medium storing computer readable instructions to control the completion of an interface point in a construction project, which instructions when executed by a computer processor configure the processor to:
receive data with which to define and store to a data store one or more interface agreements for the completion of the interface point, respective interface agreements are for performance by one or more contractors under the management of an owner/operator of the construction project; and
provide workflow for processing the completion of the one or more interface agreements by the one or more contractors under the management of an owner/operator, the workflow configured to provide a user interface for brokering, by the owner/operator, respective interface agreement requests and responses by the one or more contractors for completing a particular interface agreement.

21. The computer program product of claim 20 wherein the user interface is configured to receive input from an owner/operator interface manager to endorse respective interface agreement requests and responses, the workflow forwarding the endorsed requests and responses accordingly thereby to control the performance of the respective interface agreements.
